(19) United States
(12) Patent Application Publication
(10) Pub. No.: US 2025/0019240 A1
(43) Pub. Date: Jan. 16, 2025

(54) NEGATIVE ELECTRODE ACTIVE MATERIAL AND PREPARATION METHOD THEREFOR, AND NEGATIVE ELECTRODE PLATE INCLUDING SAME, ELECTROCHEMICAL APPARATUS, AND ELECTRONIC APPARATUS

(71) Applicant: Ningde Amperex Technology Limited, Ningde (CN)

(72) Inventor: Zheng YI, Ningde (CN)

(73) Assignee: Ningde Amperex Technology Limited, Ningde (CN)

(21) Appl. No.: 18/899,347

(22) Filed: Sep. 27, 2024

Related U.S. Application Data
(63) Continuation of application No. PCT/CN2022/083475, filed on Mar. 28, 2022.

(51) Int. Cl. C01B 32/05

(52) U.S. Cl. CPC C01B 32/05; C01P 2002/52; C01P 2002/85; C01P 2004/51; C01P 2004/61; C01P 2004/84; C01P 2006/40

(57) ABSTRACT

A negative electrode active material includes a hard carbon material, the hard carbon material includes a carbon element, a hydrogen element, a nitrogen element, and transition metal elements. Based on a total mass of the hard carbon material, a mass percentage of the carbon element is A %, a mass percentage of the hydrogen element is B %, a mass percentage of the nitrogen element is C %, and a mass percentage of the transition metal elements is D %, and 0.003≤B/A≤0.050, 0<C≤12.0, and 0<D≤5.0.

### CROSS REFERENCE TO THE RELATED APPLICATIONS

This application is a continuation under 35 U.S.C. § 120 of international patent application PCT/CN2022/083475 filed on Mar. 28 2022, the entire content of which is incorporated herein by reference.

### TECHNICAL FIELD

This application belongs to the electrochemical technical field, and particularly relates to a negative electrode active material and a preparation method therefor, and a negative electrode plate including the same, an electrochemical apparatus, and an electronic apparatus.

### BACKGROUND

Due to the advantages of a high energy density, a high working voltage, a long cycle life, a small size, a light weight, environmental friendliness, and the like, secondary batteries are widely applied to fields such as electric automobiles, movable electronic devices, and the like. With the continuous development of electric automobiles and movable electronic devices, requirements on energy density, cycle performance, fast charge and discharge performance, and safety performance of the secondary batteries are increasingly high. Therefore, to provide a secondary battery with comprehensively improved overall performance is the technical problem to be solved currently.

### SUMMARY

An object of this application is to provide a negative electrode active material and a preparation method therefor, and a negative electrode plate including the same, an electrochemical apparatus, and an electronic apparatus. The negative electrode active material provided by this application can have a high reversible gram volume, good electronic conductivity, and fast charge and discharge performance.

A first aspect of this application provides a negative electrode active material, including a hard carbon material, where the hard carbon material includes a carbon element, a hydrogen element, a nitrogen element, and transition metal elements. Based on the total mass of the hard carbon material, the mass percentage of the carbon element is A %, the mass percentage of the hydrogen element is B %, the mass percentage of the nitrogen element is C %, and the mass percentage of the transition metal elements is D %, and 0.003≤B/A≤0.050, 0<C≤12.0, and 0<D≤5.0.

It is found by the applicant of this applicant in a research process that in a case that appropriate amounts of nitrogen element and transition metal elements are doped into the hard carbon material, the negative electrode active material can have a high reversible gram volume, good electronic conductivity, and fast charge and discharge performance.

In some implementations, an X-ray photoelectron spectroscopy of the negative electrode active material comprises three different N peaks of pyrrole nitrogen, pyridine nitrogen, and graphitized nitrogen, a sum of a peak area corresponding to pyrrole nitrogen and a peak area corresponding to pyridine nitrogen is X, a peak area corresponding to graphitized nitrogen is Y, and 0.6≤X/Y≤1.4. Optionally, 0.7≤X/Y≤1.3. In this case, the negative electrode active material may include more pyrrole nitrogen and pyridine nitrogen. Therefore, a graphite microcrystal end surface has more defects. In this case, the effect of reducing band gap energy by nitrogen atoms may be fully exerted, so that the hard carbon material provided by this application may have good electronic conductivity and fast charge and discharge performance.

In some implementations, 65≤A≤96. Optionally, 70≤A≤94.

In some implementations, 0.3≤B≤4.0. Optionally, 1.0≤B≤2.5.

In some implementations, 0.1≤C≤12.0. Optionally, 5.0≤C≤12.0. In a case that the content of the nitrogen element is in the appropriate range, the good electronic conductivity and fast charge and discharge performance of the hard carbon material may be better improved, and the platform voltage of the hard carbon material at a high potential is further reduced, so that the output voltage and the energy density of the electrochemical apparatus as a whole are further improved.

In some implementations, 0.2≤ D≤5.0. Optionally, 0.2≤ D≤1.2. In a case that the content of the transition metal elements is in the appropriate range, the good electronic conductivity and fast charge and discharge performance of the hard carbon material may be better improved, and the platform voltage of the hard carbon material at a high potential is further reduced, so that the output voltage and the energy density of the electrochemical apparatus as a whole are further improved.

In some implementations, 0.004≤B≤0.035. Optionally, 0.007≤B≤0.030.

In some implementations, 3.0≤C/D≤18. Optionally, 6.5≤C/D≤18. In a case that the content ratio of the nitrogen element to the transition metal elements is in the appropriate range, the negative electrode active material provided by this application may have a high reversible gram volume, good electronic conductivity, and fast charge and discharge performance.

In some implementations, the transition metal elements include at least one of Mn, Co, Ni, Cu, Zn, Sc, Ti, V, Cr, Fe, Y, Zr, Nb, Mo, Ru, Rh, Pd, Ag, Cd, W, Pt, and Au. Optionally, the transition metal elements comprise at least one of Mn, Co, Ni, Cu, and Zn.

In some implementations, the nitrogen element and the transition metal elements are uniformly distributed in the hard carbon material.

In some implementations, an average mass percentage of the nitrogen element in any 500 nm×500 nm area on a surface of the hard carbon material is M₁, and an average mass percentage of the nitrogen element in any 500 nm×500 nm area inside the hard carbon material is M₂, where 0.9≤M₂/M₁≤1.1.

In some implementations, an average mass percentage of the transition metal element in any 500 nm×500 nm area on a surface of the hard carbon material is M₃, and an average mass percentage of the transition metal element in any 500 nm×500 nm area inside the hard carbon material is M₄, where 0.9≤M₄/M₃≤1.1.

In some implementations, the negative electrode active material further includes a conductive carbon shell located on the surface of the hard carbon material. Optionally, the conductive carbon shell includes at least one of amorphous carbon, graphene, a carbon nanotube, and vapor deposited carbon. After the surface of the hard carbon material is coated with the conductive carbon shell, the interfacial stability of the negative electrode active material may be improved, so that the first coulombic efficiency of the negative electrode active material is improved; besides, after the surface of the hard carbon material is coated with the conductive carbon shell, the storage sites of the negative electrode active material may further be increased, so that the negative electrode active material may further have a higher reversible gram volume.

In some implementations, the volumetric particle size Dv50 of the negative electrode active material is 3-15 μm.

In some implementations, the volumetric particle size Dv99 of the negative electrode active material is 10-45 μm.

In some implementations, the volumetric particle size Dv50 of the transition metal particles in the negative electrode active material is 10-100 μm.

In some implementations, a first reversible specific capacity of the negative electrode active material at 0-2.0 V is 300-1000 mAh/g.

A second aspect of this application provides a method for preparing a negative electrode active material, including the following steps: S10, providing a hard carbon precursor, a nitrogen source, and a transition metal source; S20, uniformly mixing the hard carbon precursor, the nitrogen source, and the transition metal source to obtain an initial raw material; S30, pre-oxidizing the initial raw material obtained in S20 at a first temperature T1 to obtain a first intermediate product, wherein T1≤300° C.; and S40, performing primary sintering treatment on the first intermediate product obtained in S30 at a second temperature T2 to obtain a hard carbon material, 600° C.≤T2≤1000° C., where the hard carbon material comprises a carbon element, a hydrogen element, a nitrogen element, and transition metal elements; based on a total mass of the hard carbon material, the mass percentage of the carbon element is A %, the mass percentage of the hydrogen element is B %, the mass percentage of the nitrogen element is C %, and the mass percentage of the transition metal elements is D %, and 0.003≤B/A≤0.050, 0<C≤12.0, and 0<D≤5.0.

In some implementations, a pre-oxidizing treatment atmosphere is a micro-oxidizing atmosphere.

In some implementations, 140° C.≤T1≤300° C.

In some implementations, pre-oxidizing treatment time is 2-48 h.

In some implementations, a primary sintering treatment atmosphere is an inert atmosphere.

In some implementations, 700° C.≤T2≤1000° C.

In some implementations, the primary sintering treatment time is 1-10 h.

In some implementations, the hard carbon precursor includes at least one of a polymer, asphalt, and a biomass material.

In some implementations, the nitrogen source includes an organic amine containing 1-20 carbon atoms and a salt thereof.

In some implementations, the transition metal source includes at least one of oxides, halides, hydroxides, sulfates, carbonates, oxalates, nitrates, and acetates of the transition metal elements.

In some implementations, the method further includes S50, after uniformly mixing the hard carbon material obtained in S40 with the conductive carbon precursor, performing secondary sintering treatment at a third temperature T3, to obtain a hard carbon material having the conductive carbon shell on the surface, where T3≤1000° C.

In some implementations, a secondary sintering treatment atmosphere is an inert atmosphere.

In some implementations, 700° C.≤T3≤1000° C.

In some implementations, secondary sintering treatment time is 1-10 h.

In some implementations, the conductive carbon precursor includes at least one of graphene, a carbon nanotube and vapor deposited carbon, acetylene, a polymer, and asphalt.

A third aspect of this application provides a negative electrode plate, including a negative electrode current collector and a negative electrode film, where the negative electrode film includes the negative electrode active material in the first aspect of this application or the negative electrode active material obtained by the method in the second aspect of this application.

A fourth aspect of this application provides an electrochemical apparatus, including the negative electrode plate in the second aspect of this application.

A fifth aspect of this application provides an electronic apparatus, including the electrochemical apparatus in the fourth aspect of this application.

The negative electrode active material provided by this application contains appropriate amounts of nitrogen element and transition metal elements, so that the negative electrode active material provided by this application can have a high reversible gram volume, good electronic conductivity, and fast charge and discharge performance. Therefore, the electrochemical apparatus and the electronic apparatus using the same have improved fast charge and discharge performance and cycle performance, and also have relatively high output voltage and energy density.

### BRIEF DESCRIPTION OF DRAWINGS

FIG. 1 shows an XPS fitting result of an N peak in a negative electrode active material in example 14.

FIG. 2 shows the contents of pyrrole nitrogen, pyridine nitrogen, and graphitized nitrogen in the negative electrode active material in example 14.

FIG. 3 shows a dQ/dV-V curve of a negative electrode plate, where a curve I represents comparative example 8, a curve II represents comparative example 2, a curve III represents example 14, and a curve IV represents example 16.

### DETAILED DESCRIPTION

To make the objects, technical solutions, and advantages of the examples of this application clearer, the following clearly and completely describes the technical solutions in the examples of this application with reference to the drawings in the examples of this application. Apparently, the described examples are merely some examples of this application rather than all of the examples. Related examples described here are illustrative and are used to provide a basic understanding of this application. The examples of this application shall not be construed as limitations to this application. On the basis of the technical solutions and examples provided in this application, all other examples obtained by those skilled in the art without making creative efforts fall into the scope of protection of this application.

For briefness, some numerical value ranges are specifically disclosed herein. However, any lower limit may be combined with any upper limit to form ranges not explicitly recorded; and any lower limit may be combined with other upper limits to form ranges not explicitly recorded, and similarly, any upper limit may be combined with any other upper limits to form ranges not explicitly recorded. Besides, each independently disclosed point or single numerical value itself may be taken as the lower limit or the upper limit to be combined with any other points or single numerical value or to be combined with other lower limits and upper limits to form ranges not explicitly recorded.

In the description herein, unless otherwise specified, “above” and “under” include this number.

Unless otherwise specified, terms used in this application have the known meaning as commonly understood by those skilled in the art. Unless otherwise specified, numerical values of parameters mentioned in this application may be measured with various measuring methods commonly used in the art (for example, they may be tested according to methods given in the examples of this application).

The term “about” is used to describe and explain minor changes. When used in combination with events or situations, the terms may refer to examples in which the events or situations occur precisely and examples in which the events or situations occur approximately. For example, when used in combination with numerical values, the terms may refer to a variation range less than or equal to ±10% of the numerical values, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. Besides, sometimes quantity, ratio, and other numerical values are represented in a format of range herein. It shall be understood that this kind of range format is for convenience and conciseness and it shall be flexibly understood that this kind of range format includes not only numerical values which are definitely appointed as range limitations, but also all individual numerical values or sub-ranges in the range, like each numerical value and sub-range definitely appointed.

A list of items connected by the term “one of” or other similar terms may refer to any combination in the listed items. For example, if the items A and B are listed, the phase “at least one of A, B, and C” means only A; only B; or A and B. In another example, if the items A, B, and C are listed, the phrase “at least one of A, B, and C” means only A; or only B; only C; A and B (excluding C); A and C (excluding B); B and C (excluding A); or all of A, B, and C. The item A may include a single component or a plurality of components. The item B may include a single component or a plurality of components. The item C may include a single component or a plurality of components.

Unless otherwise specified, all implementations and optional implementations in this application may be combined with one another to form novel technical solutions, and such technical solutions shall be regarded within the disclosed content of this application.

Unless otherwise specified, all technical features and optional technical features in this application may be combined with one another to form novel technical solutions, and such technical solutions shall be regarded within the disclosed content of this application.

In the description herein, the “active ions” refer to ions intercalated and separated to and from between the positive and negative electrodes of the electrochemical apparatus, including, but not limited to, lithium ions, sodium ions, and the like.

With the application and popularization of secondary batteries, they are increasingly concerned in terms of energy density, cycle performance, and fast charge and discharge performance. The performance of the negative electrode active material decides the performance of the secondary battery to a certain extent. Graphite, the most common negative electrode active material at present features less polarization, stable charge and discharge platform, and the like. However, the performance of commercial graphite is nearly developed to its limit currently, the room for improvement of the reversible gram volume and the energy density thereof is quite limited. Hard carbon, one of the potential negative electrode active materials capable of replacing graphite, has the advantage of high reversible gram volume, so that it can improve the energy density of the secondary battery well.

Hard carbon, in terms of definition, refers to carbon hardly graphitized, and is also hardly graphitized at a high temperature of 2500° C. or more. Hard carbon is usually obtained by pyrolyzing a precursor such as a high polymer. In the pyrolyzing process, a cross-linking structure of carbon atoms in the precursor hinders the growth of a carbon layer in a plane direction. Therefore, there will be a lot of unordered microcrystallines of a graphite-like structure (graphite microcrystallines for short) in the hard carbon structure. Moreover, hard carbon further has abundant micropores and defect structures, facilitating separation and intercalation of the ions.

However, it is found by the applicant of this application in a research process that when hard carbon is used as the negative electrode active material, there will be some deficiencies in preparation and use thereof. For example, hard carbon is sensitive to a sintering temperature. In a case that the sintering temperature is relatively high, the gram volume of hard carbon decreases rapidly; in a case that the sintering temperature is relatively low, the pyrolysis degree of the precursor is not high enough, which results in a relatively high content of hydrogen element in the obtained hard carbon structure. Therefore, the electronic conductivity and the fast charge and discharge performance of hard carbon are relatively poor.

Besides, in the charge process, the dQ/dV-V curve of hard carbon (the longitudinal axis is the differential of the gram volume to the voltage, and the transverse axis is the voltage) usually has two oxidization peaks (corresponding to two voltage platforms of the voltage-gram volume curve), where the platform voltage at a high potential is usually greater than 0.8V, and the platform voltage at a low potential is usually less than 0.2V. As far as low-temperature hard carbon obtained by a low-temperature (usually lower than 1000° C.) sintering process, the platform voltage at the high potential thereof is usually high, which results in a relatively low output voltage of the battery as a whole. Therefore, the energy density of the battery is relatively low. Moreover, as far as low-temperature hard carbon obtained by a low-temperature (usually lower than 1000° C.) sintering process, the platform voltage at the high potential thereof is usually high, the platform voltage at the low potential thereof is usually low, and the irreversible capacity corresponding to hard carbon is also high, so that the energy density of the battery is further reduced.

Through a great number of studies and practices, the applicant of this application provides a novel negative electrode active material, which can have a high reversible gram volume, good electronic conductivity, and fast charge and discharge performance.

### Negative Electrode Active Material

A first aspect of an implementation of this application provides a negative electrode active material, including a hard carbon material, where the hard carbon material includes a carbon element, a hydrogen element, a nitrogen element, and transition metal elements. Based on the total mass of the hard carbon material, the mass percentage of the carbon element is A %, the mass percentage of the hydrogen element is B %, the mass percentage of the nitrogen element is C %, and the mass percentage of the transition metal elements is D %, and 0.003≤B/A≤0.050, 0<C≤12.0, and 0<D≤5.0.

The hard carbon material provided by this application may be the low-temperature hard carbon material, that is, the hard carbon material obtained at the temperature of sintering treatment below 1000° C. Therefore, the content of the hydrogen element thereof is usually high, and the mass ratio of the hydrogen element to the carbon element is usually 0.003-0.050, so that the electronic conductivity and the fast charge and discharge performance of the hard carbon material are relatively poor. It is found by the applicant of this applicant in a research process that in a case that appropriate amounts of nitrogen element and transition metal element are doped into the hard carbon material, the negative electrode active material can have a high reversible gram volume, good electronic conductivity, and fast charge and discharge performance.

Not restrained by any theory, the applicant of this application speculates possible reasons, including the following:

First, the appropriate amounts of the nitrogen element and the transition metal elements contribute to improving element composition at the defect sites of the hard carbon material and the edges of the graphite microcrystallines (that is, the end surface). In a case that the nitrogen element exists on the graphite microcrystal end surface, it may exist in the form of azacyclo (for example, pyrrole, pyridine, and the like). Therefore, nitrogen atoms may serve as electronic carriers to play a role of reducing the band gap energy, so as to further change the electronic structure of the hard carbon material as a whole, thereby improving the electronic conductivity and the fast charge and discharge performance thereof.

Second, the transition metal elements are good carriers for electrons. Therefore, to dope the appropriate amount of transition metal elements into the hard carbon material may improve the electronic conductivity and the fast charge and discharge performance thereof.

Third, the appropriate amounts of the nitrogen element and the transition metal elements contribute to improving the adsorption and desorption capacities of the defect sites of the hard carbon material and the graphite microcrystal end surface to active ions to reduce the platform voltage of the hard carbon material at the high level and reduce the irreversible capacity of the hard carbon material at the low potential, thereby further improving the output voltage and the energy density of the electrochemical apparatus as a whole.

Fourth, the appropriate amounts of the nitrogen element and the transition metal elements further contribute to adjusting the existing positions and existing forms of the hydrogen element in the hard carbon material obtained in an equivalent sintering process, so as to further improve the platform capacity of the hard carbon material at the high potential.

In some examples, an X-ray photoelectron spectroscopy (XPS) of the negative electrode active material includes three different N peaks of pyrrole nitrogen, pyridine nitrogen, and graphitized nitrogen, a sum of a peak area corresponding to pyrrole nitrogen and a peak area corresponding to pyridine nitrogen is X, a peak area corresponding to graphitized nitrogen is Y, and 0.6≤X/Y≤1.4.

In the negative electrode active material doped with the appropriate amount of nitrogen element, the nitrogen element mainly includes three different forms: pyrrole nitrogen, pyridine nitrogen, and graphitized nitrogen. Nitrogen atoms in the graphitized nitrogen are obtained by replacing sp2 in the graphite microcrystallines, and the main body structure of the graphite microcrystallines is rarely changed. Pyrrole nitrogen and pyridine nitrogen usually have incomplete five-membered ring or six-membered ring structures, and are usually only exist on the graphite microcrystal end surface. Therefore, X/Y may reflect the degree and element composition of the defects on the graphite microcrystal end surface of the hard carbon material to a certain extent.

In the negative electrode active material provided by this application, 0.6≤X/Y≤1.4, so that the negative electrode active material may include more pyrrole nitrogen and pyridine nitrogen. Therefore, a graphite microcrystal end surface has more defects. In this case, the effect of reducing band gap energy by nitrogen atoms may be fully exerted, so that the hard carbon material provided by this application may have good electronic conductivity and fast charge and discharge performance. Moreover, in a case that the graphite microcrystal end surface contains a lot of pyrrole nitrogen and pyridine nitrogen, the content of C—H bonds at the site is relatively decreased, so that the existing positions and existing forms of the hydrogen element in the hard carbon material may further be changed, and the platform voltage of the hard carbon material at the high potential is reduced, thereby finally improving the output voltage and the energy density of the electrochemical apparatus as a whole.

In some examples, X/Y may be about 0.6, about 0.7, about 0.8, about 0.9, about 1.0, about 1.1, about 1.2, about 1.3, and about 1.4 or a range formed by any numerical values above. Optionally, 0.6≤X/Y≤1.3, 0.6≤X/Y≤1.2, 0.6≤X/Y≤1.1, 0.6≤X/Y≤1.0, 0.6≤X/Y≤0.9, 0.7≤X/Y≤1.4, 0.7≤X/Y≤1.3, 0.7≤X/Y≤1.2, 0.7≤X/Y≤1.1, 0.7≤X/Y≤1.0, or 0.7≤X/Y≤0.9.

In this application, peak areas corresponding to pyrrole nitrogen, pyridine nitrogen, and graphitized nitrogen may be calculated through an N peak fitting area corresponding to the X-ray photoelectron spectroscopy (XPS). For example, in an N peak fine spectrum obtained by fitting an XPS test through XPS PEAK analysis software, pyrrole nitrogen is defined at 399.6±0.3 eV, pyridine nitrogen is defined at 398.5±0.3 eV, and graphitized nitrogen is defined at 400.9±0.3ϵV. Then, fitting areas of different N peaks may be obtained through the XPS PEAK analysis software.

In some examples, B/A may be about 0.003, about 0.004, about 0.005, about 0.006, about 0.007, about 0.008, about 0.009, about 0.010, about 0.012, about 0.014, about 0.016, about 0.018, about 0.021, about 0.024, about 0.027, about 0.030, about 0.035, about 0.040, about 0.045, and about 0.050 or a range formed by any numerical values above. Optionally, 0.004≤B/A≤0.050, 0.004≤B/A≤0.040, 0.004≤B/A≤0.035, 0.004≤B/A≤0.030, 0.004≤B/A≤0.027, 0.005≤B/A≤0.050, 0.005≤B/A≤0.040, 0.005≤B/A≤0.035, 0.005≤B/A≤0.030, 0.005≤B/A≤0.027, 0.007≤B/A≤0.050, 0.007≤B/A≤0.040, 0.007≤B/A≤0.035, 0.007≤B/A≤0.030, 0.007≤B/A≤0.027, 0.010≤B/A≤0.050, 0.010≤B/A≤0.040, 0.010≤B/A≤0.035, 0.010≤B/A≤0.030, or 0.010≤B/A≤0.027.

In some examples, 65≤A≤96. For example, A may be about 65, about 68, about 72, about 74, about 76, about 78, about 80, about 82, about 84, about 86, about 88, about 90, about 92, about 94, and about 96, or a range formed by any numerical values above. Optionally, 70≤A≤94, 72≤A≤92, 72≤A≤90, 72≤A≤88, 72≤A≤86, 74≤A≤94, 74≤A≤92, 74≤A≤90, 74≤A≤88, 74≤A≤86, 76≤A≤94, 76≤A≤92, 76≤A≤90, 76≤A≤88, 76≤A≤86, 78≤A≤94, 78≤A≤92, 78≤A≤90, 78≤A≤88, or 78≤A≤86.

In some examples, 0.3≤B≤4.0. For example, B may be about 0.4, about 0.6, about 0.8, about 1.0, about 1.2, about 1.4, about 1.6, about 1.8, about 2.0, about 2.5, about 3.0, about 3.5, and about 4.0 or a range formed by any numerical values above. Optionally, 0.6≤B≤4.0, 0.6≤B≤3.5, 0.6≤B≤3.0, 0.6≤B≤2.5, 0.6≤B≤2.0, 0.8≤B≤4.0, 0.8≤B≤3.5, 0.8≤B≤3.0, 0.8≤B≤2.5, 0.8≤B≤2.0, 1.0≤B≤4.0, 1.0≤B≤3.5, 1.0≤B≤3.0, 1.0≤B≤2.5, or 1.0≤B≤2.0.

In a case that the content of the nitrogen element is in the appropriate range, the good electronic conductivity and fast charge and discharge performance of the hard carbon material may be better improved, and the platform voltage of the hard carbon material at a high potential is further reduced, so that the output voltage and the energy density of the electrochemical apparatus as a whole are further improved. In some examples, 0.1≤C≤12.0. In some examples, C is about 0.2, about 0.5, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, about 10.0, about 10.5, about 11.0, about 11.5, and about 12.0 or a range formed by any numerical values above. Optionally, 2.0≤C≤12.0, 3.0≤C≤12.0, 3.5≤C≤12.0, 4.0≤C≤12.0, 4.5≤C≤12.0, 5.0≤C≤12.0, 5.5≤C≤12.0, 6.0≤C≤12.0, 6.5≤C≤12.0, 7.0≤C≤12.0, 7.5≤C≤12.0, 2.0≤C≤10.5, 3.0≤C≤10.5, 3.5≤C≤10.5, 4.0≤C≤10.5, 4.5≤C≤10.5, 5.0≤C≤10.5, 5.5≤C≤10.5, 6.0≤C≤10.5, 6.5≤C≤10.5, 7.0≤C≤10.5, or 7.5≤C≤10.5.

In a case that the content of the transition metal elements is in the appropriate range, the good electronic conductivity and fast charge and discharge performance of the hard carbon material may be better improved, and the platform voltage of the hard carbon material at a high potential is further reduced, so that the output voltage and the energy density of the electrochemical apparatus as a whole are further improved. In some examples, 0.2≤D≤5.0. For example, D is about 0.2, about 0.3, about 0.4, about 0.5, about 0.6, about 0.7, about 0.8, about 0.9, about 1.0, about 1.2, about 1.5, about 2.0, about 2.5, about 3.0, about 3.5, about 4.0, about 4.5, and about 5.0 or a range formed by any numerical values above. Optionally, 0.2≤D≤4.0, 0.2≤D≤3.0, 0.2≤D≤2.0, 0.2≤D≤1.5, 0.2≤D≤1.2, 0.2≤D≤0.8, 0.2≤D≤0.6, 0.3≤D≤4.0, 0.3≤D≤3.0, 0.3≤D≤2.0, 0.3≤D≤1.5, 0.3≤D≤1.2, 0.3≤D≤0.8, 0.3≤D≤0.6, 0.4≤D≤4.0, 0.4≤D≤3.0, 0.4≤D≤2.0, 0.4≤D≤1.5, 0.4≤D≤1.2, and 0.4≤D≤0.8, or 0.4≤D≤0.6.

In a case that the content ratio of the nitrogen element to the transition metal elements is in the appropriate range, the negative electrode active material provided by this application may have a high reversible gram volume, good electronic conductivity, and fast charge and discharge performance. In some examples, 3.0≤C/D≤18. In some examples, C/D may be about 3.0, about 3.5, about 4.0, about 4.5, about 5.0, about 5.5, about 6.0, about 6.5, about 7.0, about 7.5, about 8.0, about 8.5, about 9.0, about 9.5, about 10.0, about 10.5, about 11.0, about 11.5, about 12.0, about 12.5, about 13.0, about 13.5, about 14, about 15, about 16, about 17, and about 18 or a range formed by any numerical values above. Optionally, 4.0≤C/D≤18, 5.0≤C/D≤18, 6.0≤C/D≤18, 6.5≤C/D≤18, 7.0≤C/D≤18, 7.5≤C/D≤18, 8.0≤C/D≤18, 8.5≤C/D≤18, 9.0≤C/D≤18, or 10.0≤C/D≤18.

The transition metal elements with empty tracks may be complexed with lone pair electrons of the nitrogen element. This application has no particular limitation to the type of the transition metal elements, and in some examples, the transition metal elements include at least one of Mn, Co, Ni, Cu, Zn, Sc, Ti, V, Cr, Fe, Y, Zr, Nb, Mo, Ru, Rh, Pd, Ag, Cd, W, Pt, and Au. Optionally, the transition metal elements comprise at least one of Mn, Co, Ni, Cu, and Zn.

In some examples, the volumetric particle size Dv50 of the transition metal particles in the negative electrode active material is 10-100 μm. The volume particle size of the transition metal particles in the negative electrode active material may be measured by using a transmission electron microscopy (TEM). An exemplary test method includes the following step: any 200 nm×200 nm area in the hard carbon material is scanned by using the TEM in a dark field image mode to obtain a TEM graph, where highlighted particles represent the transition metal particles. The average value of the length of the longest diagonal line and the length of the shortest diagonal line of the highlighted particles is taken as the volume particle size of the transition metal particles, and the average value of multiple tests at different positions is taken as Dv50.

In some examples, the nitrogen element and the transition metal elements are uniformly distributed in the hard carbon material. For example, the average mass percentage of the nitrogen element in any 500 nm×500 nm area on the surface of the hard carbon material is M₁, the average mass percentage of the nitrogen element in any 500 nm×500 nm area in the hard carbon material is M₂, and 0.9M₂/M₁≤1.1; the average mass percentage of the transition metal elements in any 500 nm×500 nm area on the surface of the hard carbon material is M₃, the average mass percentage of the transition metal elements in any 500 nm×500 nm area in the hard carbon material is M₄, and 0.9≤M/M₃≤1.1.

Of course, the hard carbon material provided by this application further includes elements except for the carbon element, the hydrogen element, the nitrogen element, and the transition metal elements, for example, the oxygen element, and the like.

In some examples, the negative electrode active material further includes a conductive carbon shell located on the surface of the hard carbon material. After the surface of the hard carbon material is coated with the conductive carbon shell, the interfacial stability of the negative electrode active material may be improved, so that the first coulombic efficiency of the negative electrode active material is improved; besides, after the surface of the hard carbon material is coated with the conductive carbon shell, the storage sites of the negative electrode active material may further be increased, so that the negative electrode active material may further have a higher reversible gram volume. This application has no particular limitation to the type of the conductive carbon shell, and the type of the conductive carbon shell may be selected according to an actual demand. As an example, the conductive carbon shell includes, but is not limited to, at least one of amorphous carbon, graphene, a carbon nanotube, and vapor deposited carbon.

In some examples, the volumetric particle size Dv50 of the negative electrode active material is 3-15 μm. Optionally, the volume particle size Dv50 of the negative electrode active material is 3-14 μm, 3-12 μm, 3-10 μm, 3-8 μm, 4-14 μm, 4-12 μm, 4-10 μm, 4-8 μm, 5-14 μm, 5-12 μm, 5-10 μm, or 5-8 μm.

In some examples, the volumetric particle size Dv99 of the negative electrode active material is 10-45 μm. Optionally, the volumetric particle size Dv99 of the negative electrode active material is 10-40 μm, 10-36 μm, 10-32 μm, 10-28 μm, 10-24 μm, 10-20 μm, 12-40 μm, 12-36 μm, 12-32 μm, 12-28 μm, 12-24 μm, 12-20 μm, 15-40 μm, 15-36 μm, 15-32 μm, 15-28 μm, 15-24 μm, or 15-20 μm.

The negative electrode active material provided by this application may have a relatively high first reversible gram volume. In some examples, the first reversible gram volume of the negative electrode active material at 0-2.0V is 300-1000 mAh/g, optionally 350-1000 mAh/g, 380-1000 mAh/g, 400-1000 mAh/g, 420-1000 mAh/g, 450-1000 mAh/g, 480-1000 mAh/g, or 500-1000 mAh/g.

The first reversible gram volume of the negative electrode active material at 0-2.0V may be obtained by the following test method: a single side-coated negative electrode plate is cut into a certain area as a working electrode; then by taking a lithium sheet (or a sodium sheet, and the like) as a counter electrode and a porous polyethylene film as a separator, an electrolyte is injected to assembly a button battery; and the button battery is respectively discharged to 0V first with small currents in three phases: 0.05 C/50 μA/20 μA, and is subjected to 0.1 C constant current charge to 2.0V, and the first charge capacity of the button battery is recorded. The first reversible gram volume of the negative electrode active material at 0-2.0V is equal to the first charge capacity of the button battery/mass of the negative electrode active material. The specific composition of the electrolyte is not specifically limited. For example, the electrolyte may be a LiPF₆ solution with a concentration of 1 mol/L, and a solvent may be obtained by mixing ethylene carbonate (EC) with diethyl carbonate (DEC) at a mass ratio of 1:1.

In this application, the contents of the elements in the negative electrode active material may be measured by known instruments and methods in the art. For example, the contents are measured through an elemental analyzer, an X-ray photoelectron spectroscopy (XPS) analysis technique, an X-ray fluorescence (XRF) analysis technique, an inductively coupled plasma-atomic emission spectrometry (ICP-AES) analysis technique, an inductively coupled plasma mass spectrometry (ICP-MS) analysis technique, an atomic emission spectrometry (AES) analysis technique, an atomic absorption spectrum (AAS) analysis technique, and the like.

In this application, the particle sizes Dv50 and Dv99 of the material both are known meaning in the art, respectively representing corresponding particle sizes in a case that accumulative volume distribution percentages of the material reach 50% and 99%, which may be measured by known instruments and methods in the art, for example, a particle size distribution laser diffraction technique with reference to GB/T 19077-2016. An exemplary test method includes the following steps: 1 g of a sample and 20 mL of deionized water are weighed and are uniformly mixed with a micro dispersant to obtain a mixture; the mixture is placed in an ultrasonic device for ultrasonic treatment for 5 min; and the solution is poured into a sample injection system Hydro 2000SM for test, and for example, the test device is Mastersizer 3000 produced by Malvern Instruments Ltd. In the test process, in a case that a laser beam passes through the dispersive particle sample, the particle size is measured by measuring the intensity of scattered light, and then particle size distribution forming the scattering spectrogram is calculated. To ensure the accuracy of the test results, each sample may be tested more than three times, and the average value of the obtained test results is taken as a final test result.

### Preparation Method

A second aspect of an implementation of this application provides a method for preparing a negative electrode active material, including the following steps: S10, providing a hard carbon precursor, a nitrogen source, and a transition metal source; S20, uniformly mixing the hard carbon precursor, the nitrogen source, and the transition metal source to obtain an initial raw material; S30, pre-oxidizing the initial raw material obtained in S20 at a first temperature T1 to obtain a first intermediate product, where T1≤300° C.; and S40, performing primary sintering treatment on the first intermediate product obtained in S30 at a second temperature T2 to obtain a hard carbon material, 600° C.≤T2≤1000° C. The hard carbon material includes a carbon element, a hydrogen element, a nitrogen element, and transition metal elements. Based on the total mass of the hard carbon material, the mass percentage of the carbon element is A %, the mass percentage of the hydrogen element is B %, the mass percentage of the nitrogen element is C %, and the mass percentage of the transition metal elements is D %, and 0.003≤B/A≤0.050, 0<C≤12.0, and 0<D≤5.0.

The preparation method in the second aspect of the implementation of this application can prepare the negative electrode active material according to any example in the first aspect of the implementation of this application.

In the prior art, small molecules are usually used as the nitrogen source, and in the sintering process, the small molecules are volatile, resulting in relatively low doping amount and doping efficiency of the nitrogen element. In the preparation method provided by this application, the transition metal source is added. As the empty tracks of the transition metal elements may be complexed with the lone pair electrons of the nitrogen element, volatilization of the nitrogen source can be reduced, so that the doping amount and the doping efficiency of the nitrogen element are improved; and moreover, after adding the transition metal source, polymerization of the hard carbon precursor may further be promoted.

Besides, in the preparation method provided by this application, the nitrogen element and the transition metal elements are introduced in the hard carbon precursor, which, thus, ensures that the obtained hard carbon material has uniformly doped nitrogen element and transition metal elements.

This application has no particular limitation to the type of the hard carbon precursor, the nitrogen source, and the transition metal elements, and the type of the hard carbon precursor, the nitrogen source, and the transition metal elements may be selected according to an actual demand.

This application has no particular limitation to the adding amount of the hard carbon precursor, the nitrogen source, and the transition metal elements, and the adding amount of the hard carbon precursor, the nitrogen source, and the transition metal elements may be selected according to an actual demand. For example, the mass ratio of the nitrogen source to the hard carbon precursor is 5:100 to 60:100, and the mass ratio of the transition metal elements to the hard carbon precursor is 1:100 to 20:100.

In some examples, the hard carbon precursor may include at least one of a polymer, asphalt, and a biomass material. As an example, the polymer may include at least one of epoxy resin, phenolic resin, polyfurfuryl alcohol, polyvinyl alcohol, and polythiophene. As an example, the biomass material may include at least one of glucose, fructose, saccharose, maltose, starch, and cellulose. The biomass material may be either directly purchased on the market or extracted from materials such as trees and shells.

In some examples, the nitrogen source may include an organic amine containing 1-20 carbon atoms and a salt thereof (for example, quaternary ammonium salt). The organic amine includes, but is not limited to, aliphatic amine, alcohol amine, amide, alicyclic amine, aromatic amine, naphthylamine, and the like. As an example, the nitrogen source may include at least one of melamine, cetyl trimethyl ammonium bromide, cyanoguanidine, o-phenylenediamine, m-phenylenediamine, p-phenylenediamine, aniline, ethanediamine, hexamethylenediamine, hexamethylenetetramine, triethylene tetramine, and tetraethylenepentamine.

In some examples, the transition metal source may include at least one of oxides, halides, hydroxides, sulfates, carbonates, oxalates, nitrates, and acetates of the transition metal elements. Optionally, the transition metal source is soluble in water.

This application has no particular limitation to the mixing mode of the hard carbon precursor, the nitrogen source, and the transition metal source. For example, they may be subjected to polymeric mixing, reduced graphene oxide (RGO) assisted polymeric mixing, carbon nanotube (CNT) assisted polymeric mixing, dissolving mixing, vibration mixing, ball-milling mixing, shear mixing, and the like.

Polymeric mixing refers to perform a polymerization reaction on components at a certain temperature (for example, 100-120° C.) to uniformly mix the components. Particularly, in a case that the hard carbon precursor is the biomass material, the mixing mode may be used. In this case, hydroxyl in the biomass material and amino in the nitrogen source may be catalyzed by the transition metal elements to perform a condensation polymerization reaction.

RGO assisted polymeric mixing and CNT assisted polymeric mixing refer to adding a RGO or CNT solution during the polymerization reaction to uniformly mix the components.

Dissolving mixing refers to dissolving the components in a solvent (for example, water, and the like) and then drying the mixture by distillation to uniformly mix the components.

Shear mixing refers to uniformly mixing the components in a vibration condition.

Ball-milling mixing refers to uniformly mixing the components under impacting and grinding actions of balls (for example, zirconium oxide ball-milling balls).

Shear mixing refers to uniformly mixing the components under a shear force provided by a shear or a crusher with stirring paddles or blades.

In the preparation method provided by this application, the micro-oxidizing treatment is beneficial to increasing the quantity of microporous structures and oxygen-containing functional groups (for example, hydrogen, carboxyl, and the like) of the hard carbon material, which further improves the crosslinking degree of the hard carbon precursor favorably, thereby improving the porosity and the carbon yield of the hard carbon material.

In some examples, a pre-oxidizing treatment atmosphere may be a micro-oxidizing atmosphere, optionally an air atmosphere. The micro-oxidizing atmosphere refers to a protective gas with a micro-oxidizing capability or a weak oxidizing capability, and it is generally assumed that its oxidizing capability does not exceed that of air.

In some examples, 140° C.≤T1≤300° C., 140° C.≤T1≤280° C., 140° C.≤T1≤260° C., 140° C.≤T1≤240° C., 140° C.≤T1≤220° C., 140° C.≤T1≤200° C., 150° C.≤T1≤300° C., 150° C.≤T1≤280° C., 150° C.≤T1≤260° C., 150° C.≤T1≤240° C., 150° C.≤T1≤220° C., or 150° C.≤T1≤200° C.

In some examples, pre-oxidizing treatment time is 2-48 h, but this application is not limited thereto.

In some examples, a primary sintering treatment atmosphere may be an inert atmosphere. For example, the primary sintering treatment atmosphere is a nitrogen atmosphere, an argon atmosphere, a helium atmosphere, or a mixed atmosphere of any two or more of the atmospheres.

In some examples, 600° C.≤T2≤1000° C., 650° C.≤T2≤1000° C., 700° C.≤T2≤1000° C., 600° C.≤T2≤980° C., 650° C.≤T2≤980° C., 700° C.≤T2≤980° C., 600° C.≤T2≤950° C., 650° C.≤T2≤950° C., 700° C.≤T2≤950° C., 600° C.≤T2≤900° C., 650° C.≤T2≤900° C., 700° C.≤T2≤900° C., 600° C.≤T2≤850° C., 650° C.≤T2≤850° C., or 700° C.≤T2≤850° C.

In some examples, the primary sintering treatment time is 1-10 h, but this application is not limited thereto.

In some examples, the preparation method may further include S50, after uniformly mixing the hard carbon material obtained in S40 with the conductive carbon precursor, performing secondary sintering treatment at a third temperature T3, to obtain a hard carbon material having the conductive carbon shell on the surface, where T3≤1000° C.

This application has no particular limitation to the type of the conductive carbon precursor, and the type of the conductive carbon precursor may be selected according to an actual demand. In some examples, the conductive carbon precursor may include at least one of graphene, a carbon nanotube and vapor deposited carbon, acetylene, a polymer, and asphalt. As an example, the polymer may include at least one of epoxy resin, phenolic resin, polyfurfuryl alcohol, polyvinyl alcohol, and polythiophene.

In some examples, a secondary sintering treatment atmosphere may be an inert atmosphere. For example, the secondary sintering treatment atmosphere is a nitrogen atmosphere, an argon atmosphere, a helium atmosphere, or a mixed atmosphere of any two or more of the atmospheres.

In some examples, 700° C.≤T3≤1000° C., 750° C.≤T3≤1000° C., 800° C.≤T3≤1000° C., 850° C.≤T3≤1000° C., or 900° C.≤T3≤1000° C.

In some examples, the secondary sintering treatment time is 1-10 h, but this application is not limited thereto.

### Negative Electrode Plate

A third aspect of an implementation of this application provides a negative electrode plate, including a negative electrode current collector and a negative electrode film, where the negative electrode film includes the negative electrode active material in the first aspect of the implementation of this application or the negative electrode active material obtained by the method in the second aspect of the implementation of this application.

The negative electrode plate provided by this application may improve the fast charge and discharge performance and the cycle performance of the electrochemical apparatus and further improve the output voltage and the energy density of the electrochemical apparatus as a whole.

In the negative electrode plate provided by this application, the negative electrode film may be disposed on one or two surfaces of the negative electrode current collector. The negative electrode film does not exclude other negative electrode active materials except for the negative electrode active material in the first aspect of the implementation of this application. The specific type of other negative electrode active materials is not specifically limited, and may be selected according to requirements. As an example, the other negative electrode active materials may include, but are not limited to, at least one of graphite, mesocarbon microbeads (MCMB), soft carbon, and Li₄Ti₅O₁₂.

The negative electrode film further optionally includes a conductive agent. The specific type of the conductive agent is not specifically limited, and may be selected according to requirements. As an example, the conductive agent includes, but is not limited to, at least one of conductive graphite, carbon black, acetylene black, Ketjen Black, a carbon nanotube, graphene, and carbon nanofiber.

The negative electrode film further optionally includes an adhesive. The specific type of the adhesive is not specifically limited, and may be selected according to requirements. As an example, the adhesive includes, but is not limited to, at least one of styrene butadiene rubber (SBR), sodium alginate, carboxymethylcellulose, hydroxy propyl cellulose, polyvinyl alcohol, polyvinylpyrrolidone, polyurethane, and epoxy resin.

The negative electrode film further optionally includes a thickener. The specific type of the thickener is not specifically limited, and may be selected according to requirements. As an example, the thickener includes, but is not limited to, sodium carboxymethylcellulose (CMC-Na).

The negative electrode current collector may use a metal foil or a porous metal plate, for example, a foil or a porous plate of metals such as copper, nickel, titanium, ferric, and aluminum or a combination thereof. As an example, the negative electrode current collector may be a copper foil (for example, for a lithium secondary battery system) or an aluminum foil (for example, for a sodium secondary battery system).

The negative electrode plate provided by this application may be prepared by a conventional method in the art. Usually, the negative electrode active material, the optional conductive agent and adhesive, the thickener, and the like are dispersed in the solvent to form uniform negative electrode slurry, then the negative electrode slurry is coated to the negative electrode current collector, and the negative electrode current collector is subjected to steps such as drying and cold-pressing to obtain the negative electrode plate. The solvent may be N-methylpyrrolidone (NMP) or deionized water.

### Electrochemical Apparatus

A fourth aspect of an implementation of this application provides an electrochemical apparatus, including any apparatus in which an electrochemical reaction occurs to convert chemical energy and electric energy mutually. Specific examples of the apparatus may, for example, include all types of lithium secondary batteries or sodium secondary batteries. Particularly, the lithium secondary battery includes a lithium ion secondary battery, a lithium polymer secondary battery or a lithium ion polymer secondary battery, and the sodium secondary battery includes a sodium ion secondary battery.

The negative electrode plate used by the electrochemical apparatus provided by this application is the negative electrode plate in the third aspect of the implementation of this application. Therefore, the electrochemical apparatus provided by this application can have a high volume energy density, good cycle performance, and fast charge and discharge performance.

In some examples, the electrochemical apparatus provided by this application further includes a positive electrode plate, a separator, and an electrolyte.

In some examples, the positive electrode plate, the separator, and the electrolyte may be prepared into an electrode assembly through a winding process or a stacking process.

The electrochemical apparatus provided by this application further includes an outer package for packaging the electrode assembly and the electrolyte. In some examples, the outer package may be a hard shell, for example, a hard plastic shell, an aluminum shell, a steel shell, and the like. The outer package may also be a soft package, for example, a bag-type soft package. A material of the soft package may be a plastic, for example, at least one of an aluminum plastic film, polypropylene, polybutylene terephthalate, and poly(butylene succinate).

### [Positive Electrode Plate]

The material, composition, and manufacturing method of the positive electrode plate used in the electrochemical apparatus provided by this application may include any known techniques in the prior art.

In some examples, the positive electrode plate includes a positive electrode current collector and a positive electrode film located on at least one surface of the positive electrode current collector. The positive electrode film usually includes a positive electrode active material and optional conductive agent and adhesive.

In some examples, the positive electrode current collector may use a metal foil or a porous metal plate, for example, a foil or a porous plate of metals such as aluminum, copper, nickel, titanium, and silver or a combination thereof. As an example, the positive electrode current collector may be an aluminum foil.

Used in the lithium secondary battery, the positive electrode active material may include a material capable of absorbing and releasing lithium, and the specific type of the positive electrode active material is not specifically limited, and may be selected according to requirements. As an example, the positive electrode active material used in the lithium secondary battery includes, but is not limited to, at least one of lithium cobalt oxide, a lithium nickel cobalt manganese ternary material, a lithium nickel cobalt aluminum ternary material, lithium iron phosphate, a lithium-rich manganese-based material, and respective modified compounds. The modified compounds of the positive electrode active materials may be obtained by doping modification, surface coating modification or doping and coating modification on the positive electrode active materials.

Used in the sodium secondary battery, the positive electrode active material may include a material capable of absorbing and releasing sodium, and the specific type of the positive electrode active material is not specifically limited, and may be selected according to requirements. As an example, the positive electrode active material used in the sodium secondary battery includes, but is not limited to, at least one of sodium, copper, ferric, and manganese oxides, a Prussian blue material, a Prussian white material, a sodium-containing polyanion compound, and respective modified compounds. The modified compounds of the positive electrode active materials may be obtained by doping modification, surface coating modification or doping and coating modification on the positive electrode active materials.

The specific type of the conductive agent is not specifically limited, and may be selected according to requirements. As an example, the conductive agent includes, but is not limited to, at least one of conductive graphite, carbon black, acetylene black, Ketjen Black, a carbon nanotube, graphene, and carbon nanofiber.

The specific type of the adhesive is not specifically limited, and may be selected according to requirements. As an example, the adhesive includes, but is not limited to, at least one of polyvinylidene fluoride (PVDF), polytetrafluoroethylene, a vinylidene fluoride-tetrafluoroethylene-propylene terpolymer, a vinylidene fluoride-hexafluoropropylene-tetrafluoroethylene terpolymer, a tetrafluoroethylene-hexafluoropropylene copolymer, a tetrafluoroethylene-hexafluoropropylene copolymer, and polyvinyl alcohol.

The positive electrode plate provided by this application may be prepared by a conventional method in the art. Usually, the positive electrode active material, the optional conductive agent and adhesive, and the like are dispersed in the solvent to form uniform positive electrode slurry, then the negative electrode slurry is coated to the positive electrode current collector, and the positive electrode current collector is subjected to steps such as drying and hot-pressing to obtain the positive electrode plate. The solvent may be N-methylpyrrolidone, but this application is not limited thereto.

### [Electrolyte]

The electrolyte plays a role of conducting active ions between the positive electrode plate and the negative electrode plate. The electrolyte capable of being used in the electrochemical apparatus provided by this application may be a known electrolyte in the prior art.

In some examples, the electrolyte includes an organic solvent, an electrolyte salt, and an optional additive, and types of the organic solvent, the electrolyte salt, and the additive are not specifically limited and may be selected according to requirements.

In some examples, used in the lithium secondary battery, the electrolyte salt (that is, the lithium salt) includes, but is not limited to, lithium hexafluorophosphate (LiPF₆), lithium tetrafluoroborate (LiBF₄), lithium perchlorate (LiClO₄), lithium hexafluoroarsenate (LiAsF₆), lithium bis(fluorosulfonyl)imide (LiFSI), lithium bis(trifluoromethanesulphonyl)imide (LiTFSI), lithium trifluoromethanesulfonate (LiTFS), lithium difluoro(oxalato)borate (LiDFOB), and lithium bis(oxalate) borate (LiBOB).

Used in the sodium secondary battery, as an example, the electrolyte salt (that is, the lithium salt) includes, but is not limited to, at least one of sodium hexafluorophosphate (NaPF₆) and sodium perchlorate (NaClO₄).

In some examples, as an example, the organic solvent includes, but is not limited to, at least one of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), butyl carbonate (BC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), gamma butyrolactone (GBL), sulfolane (SF), methyl sulfonyl methane (MSM), ethyl methyl sulfone (EMS), and ethyl sulfonyl ethane (ESE).

In some examples, the additive includes, but is not limited to, at least one of a negative electrode film forming additive and a positive electrode film forming additive. As an example, the additive includes, but is not limited to, at least one of fluoroethylene carbonate (FEC), vinylene carbonate (VC), vinyl ethylene carbonate (VEC), ethylene sulfate (DTD), trimethylene sulfite, ethylene sulfite (ES), propane sultone (PS), prop-1-ene-1,3-sultone (PST), sulfonate cyclic quaternary ammonium salt, succinic anhydride, succinonitrile (SN), adiponitrile (AND), tris(trimethylsilyl)phosphate (TMSP), and tris(trimethylsilyl) borate (TMSB).

The electrolyte provided by this application may be prepared by a conventional method in the art. For example, the organic solvent, the electrolyte salt, and the optional additive may be uniformly added to obtain the electrolyte. There is no particular limitation to the adding sequence of the materials. For example, the electrolyte salt and the optional additive may be added into the organic solvent to be uniformly mixed to obtain the electrolyte; or, the electrolyte salt is first added into the organic solvent, and then the optional additive is added into the organic solvent to be uniformly mixed to obtain the electrolyte.

### [Separator]

The separator is disposed between the positive electrode plate and the negative electrode plate to mainly play a role of preventing the positive and positive electrodes from being short-circuited and making active ions pass through. This application has no particular limitation to the type of the separator, and any known porous structure separator with good chemical stability and mechanical stability may be used. The separator may be either a single-layer film or a multi-layer composite film. In a case that the separator is the multi-layer composite film, the materials of the layers may be the same or different.

In some examples, the separator includes a polymer or an inorganic matter, and the like formed by a material stable to the electrolyte provided by this application.

For example, the separator may include a substrate layer and an optional surface treatment layer. The substrate layer is a non-woven fabric, a membrane or a composite membrane with the porous structure, and the material of the substrate layer includes at least one of polyethylene, polypropylene, polyethylene glycol terephthalate, and polyimide. As an example, a polypropylene porous membrane, a polyethylene porous membrane, a polypropylene non-woven fabric, a polyethylene non-woven fabric, a polypropylene-polyethylene-polypropylene porous composite membrane, a glass fiber separator, porous filter paper, and the like may be used.

The surface treatment layer may be or may not be disposed on the surface of the substrate layer. In some examples, the surface treatment layer is disposed on at least one surface of the substrate layer, and the surface treatment layer may be a polymer layer or an inorganic matter layer, and may be a layer formed by mixing the polymer with the inorganic matter.

The inorganic matter layer includes inorganic particles and an adhesive. The inorganic particles include at least one of aluminum oxide, silicon oxide, magnesium oxide, titanium oxide, hafnium dioxide, stannic oxide, cerium dioxide, nickel oxide, zinc oxide, calcium oxide, zirconium oxide, yttrium oxide, silicon carbide, bochmite, aluminum hydroxide, magnesium hydroxide, calcium hydroxide, and barium sulfate. The adhesive includes at least one of polyvinylidene fluoride, a vinylidene fluoride-hexafluoropropylene copolymer, polyamide, polyacrylonitrile, polyacrylate, polyacrylic acid, polyacrylate, polyvinylpyrrolidone, polyvinylether, polymethyl methacrylate, polytetrafluoroethylene, and polyhexafluoropropylene.

The polymer layer includes a polymer, and a material of the polymer includes at least one of polyamide, polyacrylonitrile, an acrylate polymer, polyacrylic acid, polyacrylate, polyvinylpyrrolidone, polyvinylether, polyvinylidene fluoride, and a vinylidene fluoride-hexafluoropropylene copolymer.

### Electronic Device

A fourth aspect of an implementation of this application provides an electronic apparatus, including the electrochemical apparatus in the third aspect of the implementation of this application.

There is no particular limitation to the electronic apparatus provided by this application, and the electronic apparatus may be any known electronic apparatus in the prior art. In some examples, the electronic apparatus may include, but is not limited to, a notebook computer, a pen input type computer, a mobile computer, an E-book player, a portable phone, a portable fax machine, a portable copying machine, a portable printer, a head-mounted stereo headphone, a video tape recorder, a liquid crystal television, a handheld cleaner, a portable CD machine, a mini disk, a transceiver, an electronic notebook, a calculator, a storage card, a portable sound recorder, a radio, a standby power supply, a motor, an automobile, a motorcycle, an assistant bicycle, a bicycle, a lighting apparatus, a toy, a game machine, a clock, an electric tool, a flash light, a camera, a household large storage battery, a lithium ion capacitor, and the like.

### EXAMPLES

The examples below more specifically describe the content disclosed by this application. These examples are merely used for illustrative description because various modifications and variations made with the range of the content disclosed by this application are apparent to those skilled in the art. Unless otherwise specified, all parts, percentages, and ratios reported in the examples below are based on mass, and all reagents used in the examples may be commercially available or are synthesized according to conventional methods, and may be directly used without being further treated. Moreover, instruments used in the examples are commercially available.

### Testing Method

### (1) First Reversible Gram Volume and First Coulombic Efficiency Tests for Negative Electrode Active Material

A single-side coated negative electrode plate is taken and cut into wafers with the diameter being 14 mm as working electrodes, and then by taking a lithium sheet with the diameter being 18 mm as a counter electrode and a porous polyethylene film with the diameter being 20 mm as a separator, an electrolyte is injected to assemble a button battery. The button battery is discharged to 0V first with small currents in three stages: 0.05 C/50 μA/20 μA, and a first discharge capacity of the button battery is recorded; and after being left still for 10 min, the button battery is charged to 2.0V with a 0.1 C constant current, and a first charge capacity of the button battery is recorded.

First reversible gram volume (mAh/g) of negative electrode active material=first charge capacity of button battery/mass of negative electrode active material.

First coulombic efficiency of negative electrode active material=(first charge capacity of button battery/first discharge capacity of button battery)×100%.

### (2) Fast Charge and Discharge Performance Test for Lithium Ion Secondary Battery

In a 25° C. environment, the lithium ion secondary battery is charged to 4.48V with a 2 C constant current, and the charge capacity obtained in this stage is marked as Q1; then, the lithium ion secondary battery is charged at a constant voltage 4.48V till the current is less than 0.05 C, and the charge capacity in this stage is marked as Q2; and after being left still for 10 min, the lithium ion secondary battery is discharged at a 0.5 C constant current o 2.0V.

Q1+Q2 represents the total charge capacity of the lithium ion secondary battery at 2 C. In this application, Q1/(Q1+Q2) characterizes the fast charge performance of the lithium ion secondary battery. The higher the ratio is, the better the fast charge performance of the lithium ion secondary battery is.

### (3) Cycle Performance Test for Lithium Ion Secondary Battery

In a 12° C. environment, the lithium ion secondary battery is charged to 4.48V with a 0.7 C constant current and then discharged at a constant voltage till the current is less than 0.05 C; after being left still for 10 min, the lithium ion secondary battery is discharged at a 1 C constant current o 2.0V, which is a cyclic charge and discharge process, and the discharge capacity at the time is the discharge capacity of the first cycle. The lithium ion secondary battery is subjected to 500-time charge and discharge cycles according to the above method, and the discharge capacity of the 500^{th} cycle is recorded.

Capacity retention ratio of battery after 500^{th} cycle=(discharge capacity of 500^{th} cycle/discharge capacity of first cycle)×100%

During the above tests, 5 samples are tested in each example and comparative example, and the average value of the obtained test results is taken as a final test result.

### Example 1

### Preparation of Negative Electrode Active Material

100 parts by mass of glucose (hard carbon precursor), 15 parts by mass of melamine (nitrogen source), and 2 parts by mass of cobalt sulfate (transition metal source) were mixed in a proportion and were subjected to a polymerization reaction in deionized water at 100-120° C. for 12 h; then the mixture was subjected to micro-oxidizing treatment at 180° C. in an air atmosphere for 10 h; and then the mixture was primarily sintered in an atmosphere furnace in a nitrogen atmosphere at 700° C. for 2 h, and the mixture was subjected to step crushing to obtain the negative electrode active material.

Mass percentages of the carbon element, the hydrogen element, the nitrogen element, and the transition metal elements in the negative electrode active material are tested by an elemental analyzer (German Elementar UNICUBE) and an X-ray photoelectron spectroscopy (XPS) analysis technique. Test results are respectively marked as A %, B %, C %, and D %, and are shown in table 2.

### Preparation of Negative Electrode Plate

The negative electrode active material, the adhesive styrene butadiene rubber (SBR), and the thickener sodium carboxymethylcellulose (CMC-Na) were fully stirred and mixed in an appropriate amount of solvent deionized water at a mass ratio of 97:2:1 to form negative slurry with a solid content being 40%; and the negative electrode slurry was coated to a copper foil of a negative electrode current collector, and the copper foil was dried at 85° C., was subjected to cold pressing, cutting, and slicing, and was dried at 120° C. in vacuum for 12 h to obtain the negative electrode plate.

### Preparation of Positive Electrode Plate

The positive electrode active material LiCoO₂, the conductive agent carbon black (Super P), and the adhesive PVDF were fully stirred and mixed in an appropriate amount of solvent NMP at a mass ratio of 97:1.4:1.6 to form positive slurry with a solid content being 72%; and the positive electrode slurry was coated to an aluminum foil of a positive electrode current collector, and the aluminum foil was dried at 85° C., was subjected to cold pressing, cutting, and slicing, and was dried at 85° C. in vacuum for 4 h to obtain the positive electrode plate.

### Preparation of Electrolyte

In a dried argon atmosphere glove box, ethylene carbonate (EC), ethyl methyl carbonate (EMC), and diethyl carbonate (DEC) were mixed at a mass ratio of 30:50:20 to obtain an organic solvent; and propane sultone, fluoroethylene carbonate, and LiPF₆ were added into the organic solvent to be uniformly mixed to obtain the electrolyte. The concentration of LiPF₆ is 1 mol/L, and based on the total mass of the electrolyte, the mass percentage of propane sultone is 1.5% and the mass percentage of fluoroethylene carbonate is 2%.

### Preparation of Separator

A porous polyethylene film with the thickness being 7 μm is used as a separator.

### Preparation of Lithium Ion Secondary Battery

The positive electrode plate, the separator, and the negative electrode plate were sequentially stacked and wound to obtain an electrode assembly, the electrode assembly was put in an outer package aluminum plastic film, the electrolyte was injected, and steps such as vacuum packaging, standing, formation, shaping, capacity test, and the like were carried out to obtain the lithium ion secondary battery.

### Examples 2-8

A method for preparing the lithium ion secondary battery is similar to that in example 1, and the difference lies in that the preparation parameters of the negative electrode active material are different. Specific parameters are shown in table 1 for details.

### Comparative Example 1

A method for preparing the lithium ion secondary battery is similar to that in example 1, and the difference lies in that the preparation parameters of the negative electrode active material are different.

100 parts by mass of glucose was subjected to micro-oxidizing treatment at 180° C. in an air atmosphere for 10 h; and then the mixture was primarily sintered in an atmosphere furnace in a nitrogen atmosphere at 700° C. for 2 h, and the mixture was subjected to step crushing to obtain the negative electrode active material.

### Comparative Example 2

A method for preparing the lithium ion secondary battery is similar to that in example 1, and the difference lies in that the preparation parameters of the negative electrode active material are different.

100 parts by mass of glucose was subjected to micro-oxidizing treatment at 180° C. in an air atmosphere for 10 h; and then the mixture was primarily sintered in an atmosphere furnace in a nitrogen atmosphere at 850° C. for 2 h, and the mixture was subjected to step crushing to obtain the negative electrode active material.

### Comparative Example 3

A method for preparing the lithium ion secondary battery is similar to that in example 1, and the difference lies in that the preparation parameters of the negative electrode active material are different.

100 parts by mass of glucose was subjected to micro-oxidizing treatment at 180° C. in an air atmosphere for 10 h; and then the mixture was primarily sintered in an atmosphere furnace in a nitrogen atmosphere at 1000° C. for 2 h, and the mixture was subjected to step crushing to obtain the negative electrode active material.

### Comparative Example 4

A method for preparing the lithium ion secondary battery is similar to that in example 1, and the difference lies in that the preparation parameters of the negative electrode active material are different.

100 parts by mass of glucose (hard carbon precursor) and 15 parts by mass of melamine (nitrogen source) were mixed in a proportion and were subjected to micro-oxidizing treatment at 180° C. in an air atmosphere for 10 h; and then the mixture was primarily sintered in an atmosphere furnace in a nitrogen atmosphere at 850° C. for 2 h, and the mixture was subjected to step crushing to obtain the negative electrode active material.

### Comparative Example 5

A method for preparing the lithium ion secondary battery is similar to that in example 1, and the difference lies in that the preparation parameters of the negative electrode active material are different.

100 parts by mass of glucose (hard carbon precursor), 15 parts by mass of melamine (nitrogen source), and 2 parts by mass of reduced graphene oxide (RGO) were mixed in a proportion and were subjected to micro-oxidizing treatment at 180° C. in an air atmosphere for 10 h; and then the mixture was primarily sintered in an atmosphere furnace in a nitrogen atmosphere at 850° C. for 2 h, and the mixture was subjected to step crushing to obtain the negative electrode active material.

TABLE 1

| | Carbon | | | | Transition | | | |
|---|---|---|---|---|---|---|---|---|
| | precursor | | Nitrogen source | | metal source | | | |
| | | Part | | Part | | Part | Primary sintering | |
| Sequence | | by | | by | | by | treatment | |
| number | Type | mass | Type | mass | Type | mass | T1(° C.) | Time(h) |
| Example 1 | Glucose | 100 | Melamine | 15 | Cobalt | 2 | 700 | 2 |
| | | | | | sulfate | | | |
| Example 2 | Glucose | 100 | Melamine | 20 | Cobalt | 2 | 700 | 2 |
| | | | | | sulfate | | | |
| Example 3 | Glucose | 100 | Melamine | 35 | Cobalt | 2 | 700 | 2 |
| | | | | | sulfate | | | |
| Example 4 | Glucose | 100 | Melamine | 15 | Cobalt | 2 | 850 | 2 |
| | | | | | sulfate | | | |
| Example 5 | Glucose | 100 | Melamine | 35 | Cobalt | 2 | 850 | 2 |
| | | | | | sulfate | | | |
| Example 6 | Glucose | 100 | Melamine | 15 | Cobalt | 2 | 1000 | 2 |
| | | | | | sulfate | | | |
| Example 7 | Glucose | 100 | Melamine | 35 | Cobalt | 2 | 1000 | 2 |
| | | | | | sulfate | | | |
| Example 8 | Glucose | 100 | Melamine | 15 | Nickel | 2 | 850 | 2 |
| | | | | | sulfate | | | |

TABLE 2

| | | | | | | | First | |
|---|---|---|---|---|---|---|---|---|
| | | | | | | | reversible | |
| | | | | | | | gram | Q1/ |
| Sequence | A | B | B/ | C | D | C/ | volume | (Q1 + |
| number | (%) | (%) | A | (%) | (%) | D | (mAh/g) | Q2) |
| Example 1 | 72 | 1.32 | 0.018 | 5.70 | 0.56 | 10.18 | 580 | 74% |
| Example 2 | 71 | 1.48 | 0.021 | 6.50 | 0.54 | 12.06 | 600 | 76% |
| Example 3 | 70 | 1.87 | 0.027 | 10.20 | 0.60 | 17.00 | 750 | 79% |
| Example 4 | 77.3 | 1.03 | 0.013 | 4.50 | 0.57 | 7.92 | 470 | 79% |
| Example 5 | 74 | 1.30 | 0.018 | 7.80 | 0.58 | 13.45 | 490 | 85% |
| Example 6 | 93 | 0.70 | 0.008 | 3.62 | 0.53 | 6.83 | 385 | 83% |
| Example 7 | 90 | 0.90 | 0.010 | 6.10 | 0.56 | 10.89 | 390 | 88% |
| Example 8 | 78 | 1.11 | 0.014 | 4.44 | 0.55 | 8.07 | 520 | 80% |

TABLE 3

| | First reversible | |
|---|---|---|
| Sequence number | gram volume (mAh/g) | Q1/(Q1 + Q2) |
| Comparative example 1 | 470 | 70% |
| Comparative example 2 | 450 | 75% |
| Comparative example 3 | 380 | 79% |
| Comparative example 4 | 465 | 77% |
| Comparative example 5 | 460 | 78% |

Table 2 shows the self-discharge test results of examples 1-8 and table 3 shows the test results of comparative examples 1-5.

It may be seen from the test results of comparatives 1-3 that with the increase of the primary sintering temperature, the first reversible gram volume of the negative electrode active material is reduced, and the fast charge performance of the lithium ion secondary battery is slightly improved. It may be seen from the test results of comparative examples 2, 4, and 5 that to only dope the nitrogen element into the negative electrode active material has a limited improvement effect on the first reversible gram volume of the negative electrode active material and the fast charge performance of the lithium ion secondary battery.

It may be seen from the test results of examples 1-8 and comparative examples 1-5 that after doping appropriate amounts of both the nitrogen element and the transition metal elements into the negative electrode active material, the first reversible gram volume of the negative electrode active material and the fast charge performance of the lithium ion secondary battery both are obviously improved.

It may be seen from the test results of examples 1-8 that in a case that the transition metal source is the same in mass, with the increase of the mass of the nitrogen source, the content of the nitrogen element doped into the negative electrode active material increases as well, and moreover, the fast charge performance of the lithium ion secondary battery is also improved. A probable reason lies in that the negative electrode active material prepared in examples 1-8 is a low-temperature hard carbon material, where the content of the nitrogen element is usually high, resulting in relatively poor electronic conductivity and fast charge and discharge performance of the negative electrode active material; after the appropriate amounts of the nitrogen element and the transition metal elements are doped, the elements may serve as good carriers of electrons, so that the electronic conductivity of the negative electrode active material is improved; moreover, in a case that the nitrogen element exists on the graphite microcrystal end surface, the band gap energy may also be reduced, so that the electronic structure of the negative electrode active material as a whole is changed. Therefore, the electronic conductivity of the negative electrode active material is further improved, and thus, the fast charge performance of the lithium ion secondary battery can also be improved.

Next, the applicant further studies the influence of the types of the carbon precursor and the nitrogen source on the performance of the lithium ion secondary battery.

Methods for preparing the lithium ion secondary battery in examples 9-12 and comparative examples 6-7 are similar to that in example 1, and the difference lies in that the preparation parameters of the negative electrode active material are different, specifically shown in table 4 for details. CTAB represents cetyl trimethyl ammonium bromide. Table 5 shows the test results of examples 9-12 and comparative examples 6-7.

TABLE 4

| | Carbon | | Nitrogen | | Transition | | | |
|---|---|---|---|---|---|---|---|---|
| | precursor | | source | | metal source | | Primary sintering | |
| Sequence | | Part | | Part | | Part | treatment | |
| number | Type | by mass | Type | by mass | Type | by mass | T1(° C.) | Time(h) |
| Example 9 | Saccharose | 100 | Melamine | 15 | Cobalt | 2 | 850 | 2 |
| | | | | | sulfate | | | |
| Example 10 | Saccharose | 100 | Melamine | 35 | Cobalt | 2 | 850 | 2 |
| | | | | | sulfate | | | |
| Example 11 | Saccharose | 100 | CTAB | 15 | Cobalt | 2 | 850 | 2 |
| | | | | | sulfate | | | |
| Example 12 | Saccharose | 100 | CTAB | 35 | Cobalt | 2 | 850 | 2 |
| | | | | | sulfate | | | |
| Comparative | Saccharose | 100 | / | / | / | / | 850 | 2 |
| example 6 | | | | | | | | |
| Comparative | Saccharose | 100 | / | / | Cobalt | 2 | 850 | 2 |
| example 7 | | | | | sulfate | | | |

TABLE 5

| Sequence | | | First reversible | |
|---|---|---|---|---|
| number | B/A | C(%) | gram volume (mAh/g) | Q1/(Q1 + Q2) |
| Example 9 | 0.013 | 4.30 | 460 | 79.5% |
| Example 10 | 0.019 | 7.20 | 505 | 84% |
| Example 11 | 0.012 | 3.60 | 440 | 78% |
| Example 12 | 0.017 | 6.10 | 485 | 81% |
| Comparative | 0.011 | / | 420 | 73% |
| example 6 | | | | |
| Comparative | 0.010 | / | 430 | 74% |
| example 7 | | | | |

It may be seen from the test results in comparative examples 4 and 5 in table 3 that in the preparation process of the negative electrode active material, the added nitrogen source such as melamine is easily volatilized in the sintering process, which is harmful to introducing the nitrogen element in the negative electrode active material. In the negative electrode active materials prepared in comparative examples 4 and 5, the mass percentages of the nitrogen element are respectively 1.2% and 1.8%. In the method for preparing the negative electrode active material provided by this application, the nitrogen source and the transition metal source both are added. As the empty tracks of the transition metal elements may be complexed with the lone pair electrons of the nitrogen element, volatilization of the nitrogen source can be reduced, so that the doping amount and the doping efficiency of the nitrogen element in the negative electrode active material are improved.

It may further be seen from the test results of examples 9-12 and comparative examples 6-7 that to only dope the transition metal elements into the negative electrode active material has a limited improvement effect on the first reversible gram volume of the negative electrode active material and the fast charge performance of the lithium ion secondary battery.

It may further be seen from the test results of examples 4-5 and comparative examples 9-12 that as the carbon precursor and the nitrogen source are different in type, the content of the nitrogen element doped into the negative electrode active material, the first reversible gram volume of the negative electrode active material, and the fast charge performance of the lithium ion secondary battery will be slightly different.

Next, the applicant further studies the influence of the mass of the transition metal source on the content of the nitrogen element doped into the negative electrode active material.

Methods for preparing the lithium ion secondary battery in examples 13-15 are similar to that in example 1, and the difference lies in that the preparation parameters of the negative electrode active material are different, specifically shown in table 6 for details.

TABLE 6

| | Carbon | | Nitrogen | | Transition | | Primary | | | | |
|---|---|---|---|---|---|---|---|---|---|---|---|
| | precursor | | source | | metal source | | sintering | | | | |
| | | Part | | Part | | Part | treatment | | | | |
| Sequence | | by | | by | | by | T1 | Time | C | D | |
| number | Type | mass | Type | mass | Type | mass | (° C.) | (h) | (%) | (%) | C/D |
| Example | Glucose | 100 | Melamine | 30 | Nickel | 1 | 850 | 2 | 3.90 | 0.298 | 13.1 |
| 13 | | | | | sulfate | | | | | | |
| Example | Glucose | 100 | Melamine | 30 | Nickel | 2 | 850 | 2 | 7.50 | 0.557 | 13.5 |
| 14 | | | | | sulfate | | | | | | |
| Example | Glucose | 100 | Melamine | 30 | Nickel | 4 | 850 | 2 | 7.90 | 1.190 | 6.6 |
| 15 | | | | | sulfate | | | | | | |

It may be seen from table 6 that with the increase of the mass of the transition metal source, the content of the nitrogen element doped into the negative electrode active material also increases, but the content of the nitrogen element will not increase continuously.

Next, the applicant further studies the influence of the type of the transition metal source on the content of the nitrogen element doped into the negative electrode active material.

Methods for preparing the lithium ion secondary battery in examples 16-20 are similar to that in example 1, and the difference lies in that the preparation parameters of the negative electrode active material are different, specifically shown in table 7 for details.

TABLE 7

| | Carbon | | Nitrogen | | Transition | | Primary | | | | |
|---|---|---|---|---|---|---|---|---|---|---|---|
| | precursor | | source | | metal source | | sintering | | | | |
| | | Part | | Part | | Part | treatment | | | | |
| Sequence | | by | | by | | by | T1 | Time | C | D | |
| number | Type | mass | Type | mass | Type | mass | (° C.) | (h) | (%) | (%) | C/D |
| Example | Glucose | 100 | Melamine | 30 | Manganese | 2 | 850 | 2 | 7.70 | 0.560 | 13.8 |
| 16 | | | | | sulfate | | | | | | |
| Example | Glucose | 100 | Melamine | 30 | Zinc | 2 | 850 | 2 | 6.80 | 0.539 | 12.6 |
| 17 | | | | | sulfate | | | | | | |
| Example | Glucose | 100 | Melamine | 30 | Cobalt | 2 | 850 | 2 | 7.30 | 0.545 | 13.4 |
| 18 | | | | | sulfate | | | | | | |
| Example | Glucose | 100 | Melamine | 30 | Copper | 2 | 850 | 2 | 7.00 | 0.568 | 12.3 |
| 19 | | | | | sulfate | | | | | | |
| Example | Glucose | 100 | Melamine | 30 | Manganese | 1 + 1 | 850 | 2 | 7.60 | 0.565 | 13.5 |
| 20 | | | | | sulfate + | | | | | | |
| | | | | | Nickel | | | | | | |
| | | | | | sulfate | | | | | | |

It may be seen from table 7 that the content of the nitrogen element doped into the negative electrode active material prepared by using different transition metal sources is slightly different. In a case that the transition metal elements are Mn, Co, and Ni, the content of the nitrogen element doped into the negative electrode active material is higher. A probable reason lies in that the transition metal elements Mn, Co, and Ni are likely to be complexed with lone pair electrons of the nitrogen element to form coordinate bonds.

Next, the applicant further studies the change of the platform voltage of the negative electrode active material at the high potential.

The negative electrode plates prepared in examples 11, 14, and 16, and comparative examples 2 and 8 are assembled into button batteries according to the method described above. Then, the button batteries are charged by using a full automatic constant current and constant voltage charger to acquire a series of voltage (V) and gram volume (Q) data. The voltage V is differentiated with the gram volume Q, and then a dQ/dV−V curve is drawn with dQ/dV as the longitudinal coordinate and the voltage Vas the transverse coordinate to obtain the specific peak voltage of the button batteries at the voltages 0.7-1.3V, that is the platform voltage at the high potential. Results are shown in table 8. Common commercially available hard carbon is used in comparative example 8.

TABLE 8

| Sequence number | X/Y | dQ/dV peak voltage at 0.7-1.3 V |
|---|---|---|
| Example 11 | 0.60 | 0.95 V |
| Example 14 | 0.91 | 0.77 V |
| Example 16 | 1.40 | 0.75 V |
| Comparative example 2 | / | 0.96 V |
| Comparative example 8 | / | 1 V |

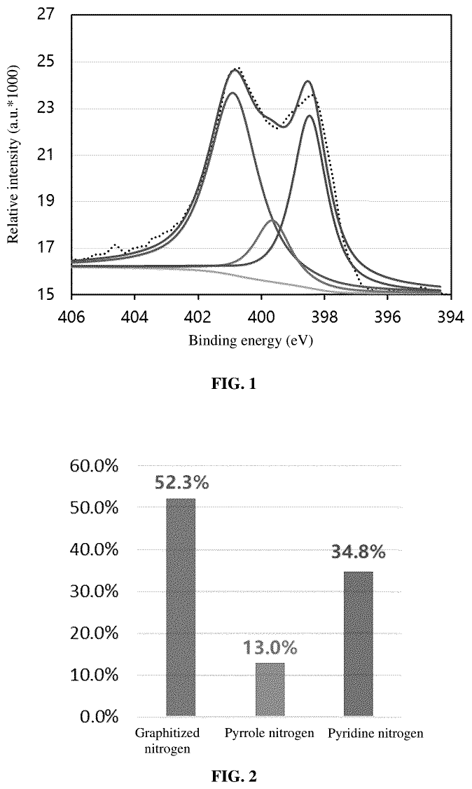

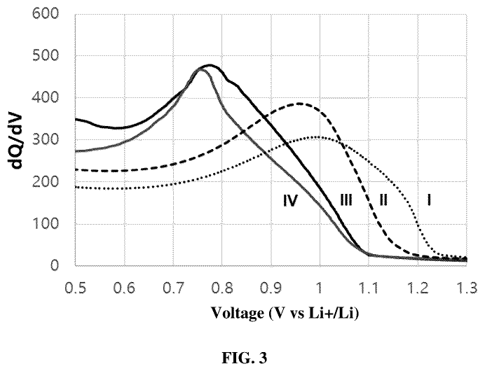

FIG. 1 shows an XPS fitting result of an N peak in a negative electrode active material in example 14. FIG. 2 shows the contents of pyrrole nitrogen, pyridine nitrogen, and graphitized nitrogen in the negative electrode active material in example 14. FIG. 3 shows a dQ/dV-V curve of a negative electrode plate, where a curve I represents comparative example 8, a curve II represents comparative example 2, a curve III represents example 14, and a curve IV represents example 16.

It may be seen from the test results in FIGS. 1-3 and table 8 that after the nitrogen element and the transition metal elements are doped into the negative electrode active material, the platform voltage of the negative electrode active material at the high potential is reduced, so that the lithium ion secondary battery as a whole may have higher output voltage and energy density.

Next, the applicant further studies the influence of different methods for preparing the negative electrode active material on the performance of the lithium ion secondary battery.

Methods for preparing the lithium ion secondary battery in examples 21-26 are similar to that in example 1, and the difference lies in that the preparation parameters of the negative electrode active material are different. Specifically, 100 parts by mass of glucose (hard carbon precursor), 18 parts by mass of melamine (nitrogen source), and 2 parts by mass of cobalt sulfate (transition metal source) were respectively mixed in different modes in examples 21-26, and were subjected to micro-oxidizing treatment at 180° C. in an air atmosphere for 10 h; and then the mixture was primarily sintered in an atmosphere furnace in a nitrogen atmosphere at 850° C. for 2 h, and the mixture was subjected to step crushing to obtain the negative electrode active material. The mixing modes used in examples 21-26 are respectively polymeric mixing, RGO assisted polymeric mixing, CNT assisted polymeric mixing, ball-milling mixing, dissolving mixing, and vibration mixing. Table 9 shows the test results of examples 21-26.

TABLE 9

| Sequence number | C(%) | Q1/(Q1 + Q2) |
|---|---|---|
| Example 21 | 4.84 | 80% |
| Example 22 | 4.81 | 80% |
| Example 23 | 4.79 | 80% |
| Example 24 | 4.50 | 77.5% |
| Example 25 | 4.65 | 79% |
| Example 26 | 4.00 | 75% |

It may be seen from the test results in table 9 that in a condition of the same raw material, the contents of the nitrogen element doped into the negative electrode active materials obtained by different mixing processes and the fast charge performance of the lithium ion secondary battery are substantially the same, with a merely slight difference.

Next, the applicant further studies the influence of the conductive carbon shell on the performance of the lithium ion secondary battery.

Methods for preparing the lithium ion secondary battery in examples 27-29 are similar to that in example 14, and the difference lies in that the surface of the hard carbon material is further coated with the conductive carbon shell. Specifically, in examples 27-29, the hard carbon material prepared in example 14, polyacrylonitrile, acetylene, and resorcinol-formaldehyde resin were respectively dispersed in deionized water to be stirred at room temperature for 10 h; then the mixture was centrifuged to collect a solid; and then the solid was subjected to secondary sintering treatment in an inert atmosphere at 900° C. for 2 h to obtain the negative electrode active material. Table 10 shows the test results of examples 14 and 27-29, and comparative example 8 (commercially available hard carbon is used).

TABLE 10

| | First | | | Capacity |
|---|---|---|---|---|
| | reversible | First | | retention |
| Sequence | gram volume | coulombic | | ratio after |
| number | (mAh/g) | efficiency | Q1/(Q1 + Q2) | 500-time cycles |
| Example 14 | 520 | 73% | 84% | 90% |
| Example 27 | 566 | 75% | 86% | 91.5% |
| Example 28 | 570 | 76% | 86% | 92% |
| Example 29 | 550 | 74% | 84% | 91% |
| Comparative | 511 | 72% | 75% | 90% |
| example 8 | | | | |

It may be seen from the test results in table 10 that after the surface of the hard carbon material is coated with the conductive carbon shell, the interfacial stability of the negative electrode active material may be improved, so that the first coulombic efficiency of the negative electrode active material and the fast charge performance and the low-temperature cycle performance of the lithium ion secondary battery are improved. Besides, after the surface of the hard carbon material is coated with the conductive carbon shell, the lithium storage sites of the negative electrode active material may further be increased, so that the negative electrode active material may further have a higher first reversible gram volume.

The above are only the specific implementations of this application and are not intended to limit the scope of protection of this application. Any modification or substitution apparent to those skilled in the art within the technical scope disclosed by this application shall fall within the scope of protection of this application. Therefore, the scope of protection of this application shall be subject to the scope of protection of the claims.

1. A negative electrode active material, comprising a hard carbon material; wherein
the hard carbon material comprises a carbon element, a hydrogen element, a nitrogen element, and transition metal elements;
based on a total mass of the hard carbon material, a mass percentage of the carbon element is A %, a mass percentage of the hydrogen element is B %, a mass percentage of the nitrogen element is C %, and a mass percentage of the transition metal elements is D %; and
0.003≤B/A≤0.050, 0<C≤12.0, and 0<D≤5.0.

2. The negative electrode active material according to claim 1, wherein an X-ray photoelectron spectroscopy of the negative electrode active material comprises three different N peaks of pyrrole nitrogen, pyridine nitrogen, and graphitized nitrogen; a sum of a peak area corresponding to pyrrole nitrogen and a peak area corresponding to pyridine nitrogen is X, a peak area corresponding to graphitized nitrogen is Y, and 0.6≤X/Y≤1.4.

3. The negative electrode active material according to claim 2, wherein 0.7≤X/Y≤1.3.

4. The negative electrode active material according to claim 1, wherein the hard carbon material satisfies at least one of the following conditions (1)-(10):

| (1) 65≤A≤96;
(2) 0.3≤B≤4.0;
(3) 0.1≤C≤12.0;
(4) 0.2≤D≤5.0;
(5) 0.004≤B/A≤0.035;
(6) 3.0≤C/D≤18;
(7) the transition metal elements comprise at least one of Mn, Co, Ni, Cu, Zn, Sc, Ti, V, Cr, Fe, Y, Zr, Nb, Mo, Ru, Rh, Pd, Ag, Cd, W, Pt, or Au;
(8) the nitrogen element and the transition metal elements are uniformly distributed in the hard carbon material;
(9) an average mass percentage of the nitrogen element in any 500 nm×500 nm area on a surface of the hard carbon material is M₁, and an average mass percentage of the nitrogen element in any 500 nm×500 nm area inside the hard carbon material is M₂, wherein 0.9≤M₂/M₁≤1.1; or
(10) an average mass percentage of the transition metal element in any 500 nm×500 nm area on a surface of the hard carbon material is M₃, and an average mass percentage of the transition metal element in any 500 nm×500 nm area inside the hard carbon material is M₄, wherein 0.9≤M₄/M₃≤1.1.

5. The negative electrode active material according to claim 1, wherein the hard carbon material satisfies at least one of the following conditions (1)-(7):

| (1) 70≤A≤94;
(2) 1.0≤B≤2.5;
(3) 5.0≤C≤12.0;
(4) 0.2≤D≤1.2;
(5) 0.007≤B/A≤0.030;
(6) 6.5≤C/D≤18; or
(7) the transition metal elements comprise at least one of Mn, Co, Ni, Cu, or Zn.

6. The negative electrode active material according to claim 1, wherein the negative electrode active material further comprises a conductive carbon shell located on the surface of the hard carbon material.

7. The negative electrode active material according to claim 6, wherein the conductive carbon shell comprises at least one of amorphous carbon, graphene, a carbon nanotube or vapor deposited carbon.

8. The negative electrode active material according to claim 1, wherein the negative electrode active material satisfies at least one of the following conditions (1)-(4):
(1) a volumetric particle size Dv50 of the negative electrode active material is 3 μm-15 μm;
(2) a volumetric particle size Dv99 of the negative electrode active material is 10 μm-45 μm;
(3) a volumetric particle size Dv50 of the transition metal particles in the negative electrode active material is 10 μm-100 μm; or
(4) a first reversible specific capacity of the negative electrode active material at 0 V-2.0 V is 300 mAh/g-1000 mAh/g.

9. A method for preparing the negative electrode active material according to claim 1, the method comprising following steps:
S10, providing a hard carbon precursor, a nitrogen source, and a transition metal source;
S20, uniformly mixing the hard carbon precursor, the nitrogen source, and the transition metal source to obtain an initial raw material;
S30, pre-oxidizing the initial raw material obtained in S20 at a first temperature T1 to obtain a first intermediate product, wherein T1≤300° C.; and
S40, performing primary sintering treatment on the first intermediate product obtained in S30 at a second temperature T2 to obtain a hard carbon material, 600° C.≤T2≤1000° C.

10. The method according to claim 9, wherein S30 satisfies at least one of the following conditions (1)-(3):
(1) the pre-oxidizing treatment atmosphere is a micro-oxidizing atmosphere;
(2) 140° C.≤T1≤300° C.; or
(3) pre-oxidizing treatment time is 2-48 h;
S40 satisfies at least one of the following conditions (4)-(6):
(4) the primary sintering treatment atmosphere is an inert atmosphere;
(5) 700° C.≤T2≤1000° C.; or
(6) primary sintering treatment time is 1-10 h;
S10 satisfies at least one of the following conditions (7)-(9):
(7) the hard carbon precursor comprises at least one of a polymer, asphalt, or a biomass material;
(8) the nitrogen source comprises an organic amine containing 1-20 carbon atoms and a salt thereof; or
(9) the transition metal source comprises at least one of oxides, halides, hydroxides, sulfates, carbonates, oxalates, nitrates, or acetates of the transition metal elements.

11. The method according to claim 9, further comprising a step S50, after uniformly mixing the hard carbon material obtained in S40 with the conductive carbon precursor, performing secondary sintering treatment at a third temperature T3, to obtain a hard carbon material having the conductive carbon shell on the surface, wherein T3≤1000° C.

12. The method according to claim 11, wherein S50 satisfies at least one of the following conditions (1)-(4):
(1) the secondary sintering treatment atmosphere is an inert atmosphere;
(2) 700° C.≤T3≤1000° C.;
(3) secondary sintering treatment time is 1-10 h; or
(4) the conductive carbon precursor comprises at least one of graphene, a carbon nanotube and vapor deposited carbon, acetylene, a polymer, or asphalt.

13. An electrochemical apparatus, comprising a negative electrode plate; the negative electrode plate comprising a negative electrode current collector and a negative electrode film;
wherein the negative electrode film comprises a negative electrode active material, comprising a hard carbon material; wherein
the hard carbon material comprises a carbon element, a hydrogen element, a nitrogen element, and transition metal elements;
based on a total mass of the hard carbon material, a mass percentage of the carbon element is A %, a mass percentage of the hydrogen element is B %, a mass percentage of the nitrogen element is C %, and a mass percentage of the transition metal elements is D %; and 0.003≤B/A≤0.050, 0<C≤12.0, and 0<D≤5.0.

14. The electrochemical apparatus according to claim 13, wherein an X-ray photoelectron spectroscopy of the negative electrode active material comprises three different N peaks of pyrrole nitrogen, pyridine nitrogen, and graphitized nitrogen; a sum of a peak area corresponding to pyrrole nitrogen and a peak area corresponding to pyridine nitrogen is X, a peak area corresponding to graphitized nitrogen is Y, and 0.6≤X/Y≤1.4.

15. The electrochemical apparatus to claim 14, wherein 0.7≤X/Y≤1.3.

16. The electrochemical apparatus according to claim 13, wherein the hard carbon material satisfies at least one of the following conditions (1)-(10):

| (1) 65≤A≤96;
(2) 0.3≤B≤4.0;
(3) 0.1≤C≤12.0;
(4) 0.2≤D≤5.0;
(5) 0.004≤B/A≤0.035;
(6) 3.0≤C/D≤18;
(7) the transition metal elements comprise at least one of Mn, Co, Ni, Cu, Zn, Sc, Ti, V, Cr, Fe, Y, Zr, Nb, Mo, Ru, Rh, Pd, Ag, Cd, W, Pt, or Au;
(8) the nitrogen element and the transition metal elements are uniformly distributed in the hard carbon material;
(9) an average mass percentage of the nitrogen element in any 500 nm×500 nm area on a surface of the hard carbon material is M₁, and an average mass percentage of the nitrogen element in any 500 nm×500 nm area inside the hard carbon material is M₂, wherein 0.9≤M₂/M₁≤1.1; or
(10) an average mass percentage of the transition metal element in any 500 nm×500 nm area on a surface of the hard carbon material is M₃, and an average mass percentage of the transition metal element in any 500 nm×500 nm area inside the hard carbon material is M₄, wherein 0.9≤M₄/M₃≤1.1.

17. The electrochemical apparatus according to claim 13, wherein the hard carbon material satisfies at least one of the following conditions (1)-(7):

| (1) 70≤A≤94;
(2) 1.0≤B≤2.5;
(3) 5.0≤C≤12.0;
(4) 0.2≤D≤1.2;
(5) 0.007≤B/A≤0.030;
(6) 6.5≤C/D≤18; or
(7) the transition metal elements comprise at least one of Mn, Co, Ni, Cu, or Zn.

18. The electrochemical apparatus according to claim 13, wherein the negative electrode active material further comprises a conductive carbon shell located on the surface of the hard carbon material.

19. The electrochemical apparatus according to claim 18, wherein the conductive carbon shell comprises at least one of amorphous carbon, graphene, a carbon nanotube or vapor deposited carbon.

20. The electrochemical apparatus according to claim 13, wherein the negative electrode active material satisfies at least one of the following conditions (1)-(4):
(1) a volumetric particle size Dv50 of the negative electrode active material is 3 μm-15 μm;
(2) a volumetric particle size Dv99 of the negative electrode active material is 10 μm-45 μm;
(3) a volumetric particle size Dv50 of the transition metal particles in the negative electrode active material is 10 μm-100 μm; or
(4) a first reversible specific capacity of the negative electrode active material at 0 V-2.0 V is 300 mAh/g-1000 mAh/g.
